(19) United States
(12) Patent Application Publication
(10) Pub. No.: US 2007/0277168 A1
(43) Pub. Date: Nov. 29, 2007

(54) Method for updating chip card applications

(75) Inventor: Eric Vetillard, Valbonne (FR)

Correspondence Address: BROWDY AND NEIMARK, P.L.L.C.;624 NINTH STREET, NW, SUITE 300, WASHINGTON, DC, 20001-5303, US

(73) Assignee: Trusted Logic, Versailles (FR)

(21) Appl. No.: 10/584,328

(22) PCT Filed: Dec. 22, 2004
(86) PCT No.: PCT/FR04/03353

§ 371 Date: Jun. 26, 2006

(30) Foreign Application Priority Data
Dec. 24, 2003 (FR) 0315487

(51) Int. Cl. G06F 9/44

(52) U.S. Cl. 717/170

(57) ABSTRACT

The invention relates to a method for enabling a new version of an application to be loaded onto a computer processing device. According to said method, information on the correspondence (I1, I3, I4, I6) between the classes (A to D) of the old version of the application and the classes (A to F) of the new version of the application, and information about correspondence between the static fields of the old version of the application and static fields of the new version of the application, is calculated prior to the loading. Said correspondence information is then associated in order to modify the objects in such a way that they point towards classes of the new version and use the new identifiers of the static fields of the new version of the application.

This invention generally relates to a method for updating chip card applications.

In particular, it is provided for loading a new release of an application into a chip card while preserving the data that had been used by the earlier releases of the application.

Most of the present chip card systems use virtual machines, the most popular of which being that of “Java Card” (a registered trademark of the Sun Microsystems company). In that system, the persistent data of the applications are stored as objects, especially as instances of classes as defined in the programs being loaded in the card. Thus, due to the persistent nature of these objects, the programs become permanently active in the card, unlike what happens in the conventional systems (workstations, desk computers). That raises a particular issue for updating the programs, since one cannot take advantage of a moment when the program is not active to update it.

Moreover, most of the platforms use an optimized binary code format (so-called “CAP File” format in the case of “Java Card”). With that format, only those data that are strictly necessary for executing the program can be loaded into a card. Particularly, it does not always include those data that are required for performing an application updating.

Lastly, a chip card is a quite particular execution context, since it is very widely distributed and often contains confidential information. Particularly, updating an application by deleting the current application and its data, reloading the new application then reloading the data can hardly be contemplated. This is because the application initialization data are generally critical and should strictly not be manipulated out of the card production sites, under highly controlled safety conditions.

The nature of the problems being experienced highly depends on the characteristics of the desired updating. For updating an application, the problems are as follows:
Simple code updating. That problem consists in correcting defects in the program, without modifying its structure. It is only needed to modify the definition of some procedures, and possibly to add new methods or even new classes (apart from the existing hierarchy).
Code updating with a modification of class hierarchy. That problem consists in correcting structural defects in the program, involving a modification of class hierarchy (usually through insertion of a class within a current hierarchy in order to take a specific behavior into account).
Updating with a modification of the object structure. That problem consists is correcting a defect involving the storage of further data, i.e. the addition of data fields in the existing classes. That problem is more complex, since the existing objects should be modified in order to take the modifications into account.

In some cases, access to the application to be updated can be gained through other applications, especially when the application exports shareable interfaces and when the application is actually a library. From a purely technical point of view, such updating procedures raise the same issues as the simple updating of applications, except that the updating should be applied to all those applications that import the amended functions.

This invention will then more specifically aim at providing a loading mechanism for a new release of an application, which supersedes an earlier application already loaded into a card, with safety and uninterrupted service warranties, such mechanism then making it possible to amend the applications without any service interruption.

It contemplates to achieve that result through a specific loading control option and a loading format that would be compatible with the format as defined in the “Java Card” specification.

In order to make such achievements, it provides generally a method for loading a new release of an application into a computer device in an object-oriented programming language and permitting, among others, the introduction of additional classes, the modification of the class hierarchy and the definition of further fields and methods.

According to the invention, that method comprises the steps of:
computing, prior to that loading, a piece of information for matching the classes of the earlier application release to the classes of the new application release;
computing, prior to that loading, a piece of information for matching the static field identifiers of the earlier application release to the static field identifiers of the new application release;
linking said matching information to the new application release as loaded into the device;
using said matching information to modify the objects so that they point at the classes of the new application release and use the new static field identifiers of the new application release.

Said matching information will advantageously comprise lookup tables.

Said tables can be omitted when these objects are not to be modified, for example, and in a non limiting way when no further class is added to the new application release or when the newly added classes do not change the class hierarchy.

The method according to the invention may include the implementation of procedures for updating the application data after the new application release has been installed.

An illustrative, non-limiting example of a mode for carrying out the invention will be described below with reference to the accompanying drawings, in which:

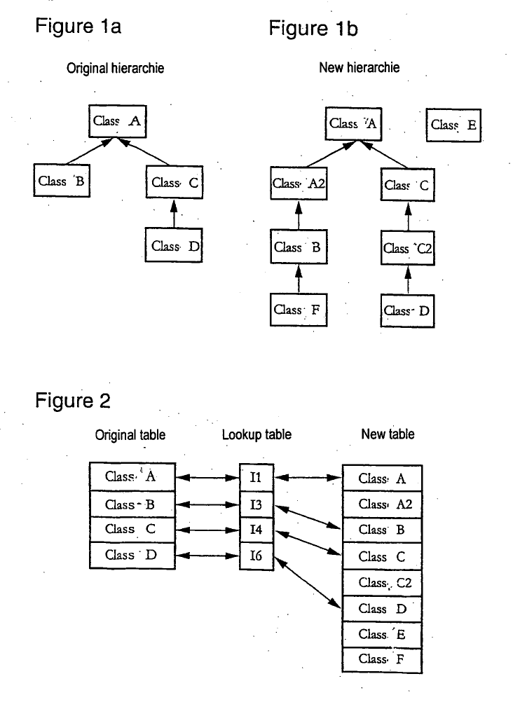

FIGS. 1a and 1b are comparative tables showing the class hierarchy of the application, in both its original release (FIG. 1a) and new release (FIG. 1b);

FIG. 2 is a lookup table providing, for each class in the original application, the index of the matching class in the new application;

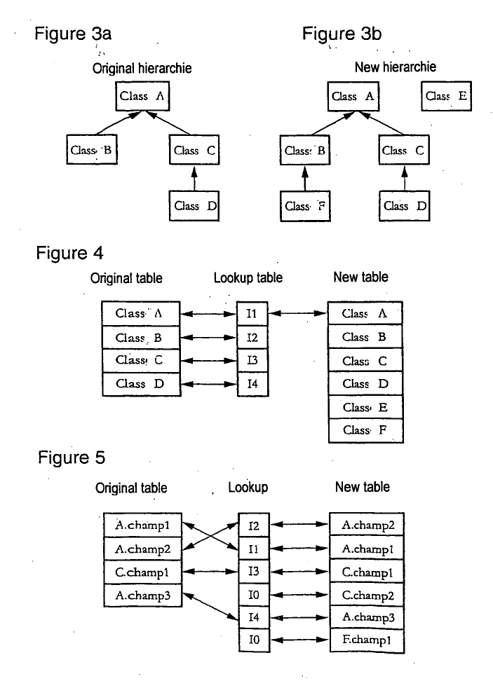

FIGS. 3a and 3b are comparative tables showing a hierarchy with the required property, namely the original hierarchy (FIG. 3a) and the new hierarchy (FIG. 3b);

FIG. 4 is a lookup table between lookup tables (original table/new table) corresponding to the hierarchy as illustrated in FIG. 3b;

FIG. 5 is a lookup table of the same type as in FIG. 4 for the static fields; and

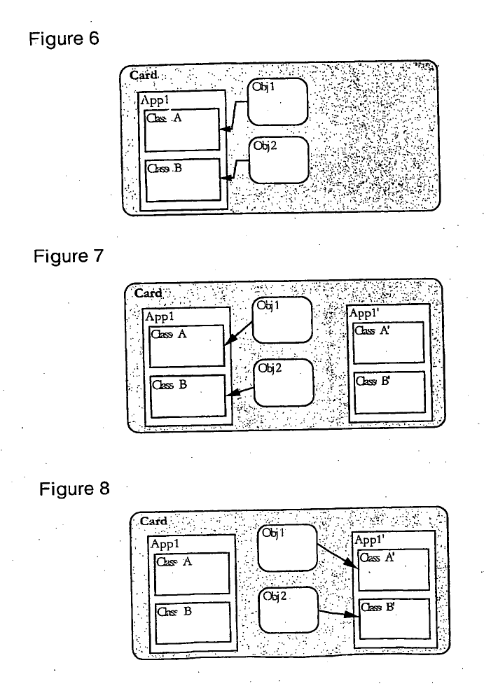

FIGS. 6-8 schematically illustrate the conditions of a chip card, prior to updating (FIG. 6), after loading the new application (FIG. 7) and after modifying the objects (FIG. 8).

The invention is implemented in several steps of:
preparing the loading file;
loading the file and editing links;
updating the application objects;
carrying out a specific updating procedure.

The loading file should contain specific information making it possible to provide the matching to one or several earlier releases of the application. In order to generate the updating file, the following objects should be made available:
all the class files of the original application;
the loading file (“CAP File” in the case of “Java Card”) of the original application;
all the class files of the new application release;
all the export files as required for building the new application release.

If the loading file of the original application includes information about the class types and names, then it is not needed to have the class files of the original application.

The input data should observe the following requirements:
For each item in the original application, an equivalent item (of the same type and with the same name) should exist in the new release of the application.
If the original application exports an interface that is external to the other applications, that external interface should remain unchanged in the new release of the application.
The export files being used in the new release of the application are binary-compatible (i.e. they can be linked without any change in the other parts of the initial application) with those being used in the original application. As regard “Java Card”, they consist in files that are listed in the import component of the original loading file.

The generated loading file is a regular loading file that should then be loaded into any card. That file contains an optional component with the following information for each earlier release of the application being considered:
the number of that release,
a table that provides a matching of each class or interface as defined in the earlier release to the new version of that class or interface in the new release of the application,
a table that provides a matching of the identifier of each static filed in the earlier release to the new identifier of that field in the new release.

These additional pieces of information are only required for the updating operations. The same binary file can then be used for loading the application and for updating applications.

In a first example, the class hierarchy of the application in both its original release and its new release are shown in FIGS. 1a and 1b. The original hierarchy includes four classes (Class A thru Class D) and the new hierarchy includes another four classes (Class E, Class F, Class A2, Class C2), some of which (Class A2 and Class C2) are inserted into the original hierarchy. In such a case, a lookup table can be prepared. As illustrated in FIG. 2, that lookup table can give, for example, for each class in the original application, the I1, I3, I4, I6 index of the corresponding class in the new application.

The example below relates to a specific case in which the additional table will not necessarily be included in the loading file, which is possible provided that:
the hierarchy of classes in the original application is kept unchanged in the new release of the application (no class is inserted into the hierarchy);
the classes in the original application are firstly defined in the new loading file and in the same sequence order as in the original loading file.

FIGS. 3a and 3b show a hierarchy with the required property in which the new hierarchy (FIG. 3b) includes classes E and F without any insertion into the original hierarchy (FIG. 3a) of classes A-D.

FIG. 4 shows the class tables corresponding to that hierarchy and observing the sequence order property as mentioned above. It can then be seen that the lookup table is trivial and is not necessary.

The file should also contain a lookup table for matching the static fields of the original application to those of the new application release. That table is similar to the previous one; it is, however, indexed by the identifiers of the new static fields; those items in the table that correspond to new fields contain an invalid identifier (I0 in the example), and the other items contain the identifier of the same field in the original release.

FIG. 5 shows an example of such a table including:
an original table comprising the fields A.champ1, A.champ2, C.champ1, A.champ3,
a new table comprising the fields A.champ2, A.champ1, C.champ1, C.champ2, A.champ3, F.champ1,
a lookup table wherein the field A.champ1 is indexed by the identifier I1, A.champ2 is indexed by the identifier I2, C.champ1 is identified by the identifier I3, A.champ3 is indexed by the identifier I4, the new fields C.champ2 and F.champ1 contain an invalid identifier=I0.

Once the appropriate file is generated, it should be loaded into the card. The card condition prior to loading is supposedly as shown in FIG. 6 with an object Obj1 in Class A and an object Obj2 in Class B of the application Appl.

Loading is performed using the regular link editing procedure of the system.

FIG. 7 shows the card condition after the new application has been loaded. The new release of application Appl' is loaded, but the application's objects Obj1, Obj2 are still pointing to the earlier release (Class A, Class B in the application Appl).

One of the loading steps consists in initializing the static fields. The standard initialization procedure is applied, except for those fields that are inherited from the original application. For these fields, the initial value as defined in the new release of the application is ignored and the earlier value is duplicated.

The next step will then consist in modifying the links of the objects so that they would point to the new classes. All the objects in the application should then be browsed and the lookup table for matching the earlier classes to the new ones should be used for identifying the new class of the object.

The result is displayed in FIG. 8, wherein the objects Obj1, Obj2 are pointing to the new classes (Class A′, Class B′).

During that step, it may happen that the objects should be modified if further fields have been added to their classes. In such a case, a new object (with the new fields) is allocated, the values of the earlier fields are duplicated from the object's earlier version, and the values of the new fields are initialized to their default values (0 for the integers, “false” for the Boolean operators and “null” for the pointers). The references to the earlier object are then updated through techniques that are conventionally implemented in the memory retrievers.

The ultimate step consists in letting the application perform all the operations that are needed for updating the data and, in particular, carrying out the initialization of the new fields (static fields, or fields inserted in objects). Those applets that have to perform an updating should implement a specific interface wherein a procedure is defined. The updating will then consist in browsing the table of applets recorded in the system and, for each applet that is an instance of a class as defined in the updated package and implemented by the updating interface, invoking the procedure with the appropriate parameters.

1. Method for loading a new application release allowing to an earlier application release into a computer device in a programming language using objects and permitting, among others, an introduction of additional classes, a class hierarchy modification and a definition of further fields and methods, said method comprising the steps of:
computing, prior to that loading, a piece of information for matching the classes of said earlier application release to the classes of the new application release;
computing, prior to that loading, a piece of information for matching the static field identifiers of the earlier application release to the static field identifiers of the new application release;
linking said matching information to the new application release as loaded into the computer device;
using said matching information to modify the objects so that they point at the classes of the new application release and they use the new static field identifiers of the new application release.

2. Method according to claim 1, characterized in that wherein said matching information are lookup tables.

3. Method according to claim 1, wherein said matching information is omitted when these objects are not to be modified, for example, and in a non limiting way when no further class is added to the new application release or when the newly added classes do not change the class hierarchy.

4. Method according to claim 1, comprising an implementation of procedures for updating application data after the new application release has been installed.

5. Method according to claim 1, wherein said computer device is a chip card.

6. Method according to claim 1, wherein said programming language is a “Java Card” language.
